(19) United States
(12) Patent Application Publication
(10) Pub. No.: US 2024/0360862 A1
(43) Pub. Date: Oct. 31, 2024

(54) Concealed Head Self-Clinching Ball Stud

(71) Applicant: Peninsula Components, Inc., San Carlos, CA (US)

(72) Inventors: Gregg Vincent Summers, Scottsdale, AZ (US); Alwin Golosinda Guittard, Litchfield Park, AZ (US)

(73) Assignee: Peninsula Components, Inc., San Carlos, CA (US)

(21) Appl. No.: 18/643,130

(22) Filed: Apr. 23, 2024

Related U.S. Application Data
(60) Provisional application No. 63/498,270, filed on Apr. 25, 2023.

(51) Int. Cl. F16B 21/07

(52) U.S. Cl. CPC F16B 21/073

(57) ABSTRACT

A self-clinching, concealed head ball stud. The ball stud includes a rounded protrusion on one end for mating with a spring clip, and a flange and a beveled structure on the other end for installation into a counterbored hole in a sheet metal panel.

### CROSS-REFERENCE

This application claims priority from U.S. Provisional Patent Application No. 63/498,270, filed Apr. 25, 2023, entitled Self-Clinching Ball Stud, the entire disclosure of which is incorporated herein by reference.

### BACKGROUND

Ball studs are well-known mechanical fastening devices used in conjunction with purposefully designed spring-catch fasteners, or clips, as a convenient method for hardware components that require repeated engagement and disengagement, such as cabinet doors, inspection panels, and the like.

A typical installation sequence for a ball stud application is shown in FIGS. 1-2. A first metal panel 10 has a hole 12 formed through the panel, and a spring catch fastener 20 is securely affixed to the metal panel 10 above the hole 12, for example, by rivets 22 or other known fasteners. In addition, a second metal panel 30 has a ball stud 40 installed through a hole 32 in the panel, and the ball stud, in this case having a male-threaded stud 41, is secured to the panel using a washer 42 and threaded nut 44. An alternative using a female-threaded ball stud would be installed in the panel with a washer and male-threaded screw. The first panel 10 and second panel 30 are then snapped together by pushing the ball stud 40 through the hole 12 in the first panel and through the spring clips 21 of the catch fastener 20.

In all cases, however, some portion of the ball stud or attachment hardware extends from and is visible from the exterior outer surfaces. Further, while a metal displacement process is known and used for captivation of many different types of fastener parts—for example, standoffs, threaded studs, guide pins and ball studs—for the most part, these products are installed from the back side of the sheet so there is a visible circular or hexagonal line around the head of the part and clear differences in material appearances. For appearance purposes alone this is normally not desirable. In areas where the designer does not want these visual incongruities, the fabricator will sometimes grind the surface smooth and then apply paint. It should be obvious that such a process is time-consuming, adds cost, and provides an opportunity for differing levels of quality. Also, there is sometimes a need to maintain a complete seal between both sides of the sheet to prevent an ingress of fluids or gases. Since the holes are punched through the sheet, the displacement of material to captivate the parts may not be sufficient.

### BRIEF DESCRIPTION OF DRAWINGS

FIG. 1 is a side elevation view of a conventional spring clip fastener affixed to a first metal panel and separately, a conventional ball stud installed in a second metal panel.

FIG. 2 is a side elevation view showing the conventional ball stud and second metal panel of FIG. 1 fastened together with the spring clip fastener and first metal panel of FIG. 1.

FIG. 3 is a side elevation view of a self-clinching ball stud positioned above a metal panel.

FIG. 4A is a side elevation view of the self-clinching ball stud shown in FIG. 3.

FIG. 4B is a bottom plan view of the self-clinching ball stud shown in FIG. 3.

FIG. 5 is a side elevation view of the self-clinching ball stud shown in FIG. 3 installed in the metal panel.

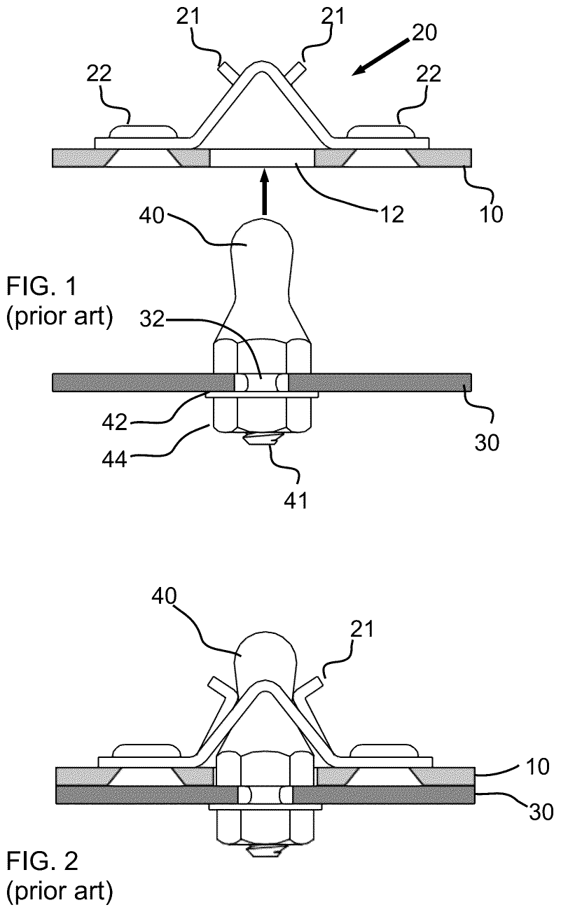

### DETAILED DESCRIPTION

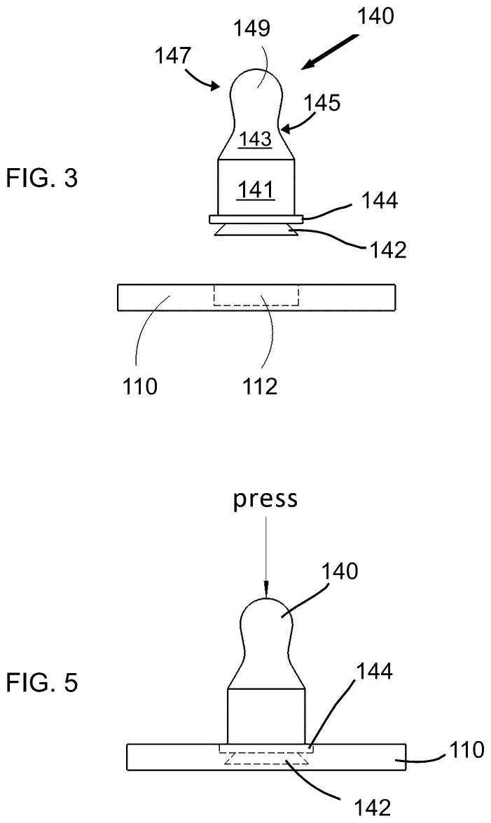

A new ball stud is designed for use with a self-clinching method that mounts in a blind counterbored hole formed in a panel. As shown in FIG. 3, the ball stud 140 looks conventional, with a body having a rounded protrusion on its top portion for engaging with a spring clip fastener. In this case, however, the bottom portion of the ball stud body includes a foot or beveled ring 142 at the bottom end and a flange or flat ring 144 between the body of the ball stud and the foot, as further described herein.

The ball stud 140 can be made in a machining process typically using one or more of the following materials: carbon steel, heat treated carbon steel, stainless steel and/or heat-treated stainless steel. Further, the ball stud 140 could be installed into either aluminum, carbon steel or stainless steel sheets. The ball stud 140 should typically be finished with zinc-plating (for carbon steels) or passivated (for stainless steels).

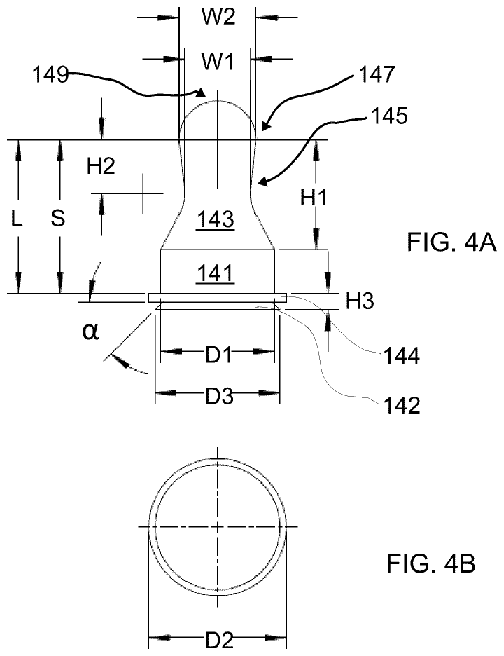

Although the ball stud could be manufactured in many different sizes, one example of a commonly sized ball stud, shown with reference to FIGS. 4A and 4B, includes a cylindrical base portion 141 with a diameter D1 measuring 0.277 inches. The ball portion 143 extends symmetrically up and in from the base portion 141 to a narrow waist portion 145 which measures W1=0.156 inches in diameter; then slightly outward to a nominal diameter at point 147 measuring W2=0.187 inches before the ball portion rounds off the at the top 149. The height H1 of the ball portion from the base portion 141 to the bulge point 147 is 0.231 inches, and the height H2 of the ball portion from the narrow waist portion 145 to the bulge point 147 is 0.102 inches. The annular flat ring has a diameter D2=0.337 inches; that is, larger than the diameter of the base portion 141.

The length of the ball stud may be varied to accommodate different material thicknesses. For example, the length S from the top of the flat ring 144 to the bulge point 147 of the ball portion 143, and the length L from the top of the flat ring to the top 149 of the ball portion, can be adjusted to provide a shorter or longer ball stud. As an example of a shorter ball stud, the length S is 0.328 inches (+/−0.005) and the length L is 0.421 inches (+/−0.010). In an example of a longer ball stud, the length S is 0.532 inches (+/−0.005) and the length L is 0.625 inches (+/−0.010).

The foot 142 is preferably a beveled circular structure, e.g., a frustum, having a maximum diameter D3=0.311 inches that is slightly smaller than that of the counterbored hole 112 in the metal sheet, while the combined height H3 of the foot and the flange 144 is slightly less than the thickness of the metal sheet. As one example, for a metal sheet having a minimum thickness of 0.062 inches, the counterbored hole should be 0.043 inches deep minimum, and the combined height H3 of the foot and flange roughly matches that depth. The bevel angle α is an acute angle but relatively large, for example, in a range between 20 degrees and 40 degrees.

In use, the metal sheet or panel 110 has a hole 112 counterbored on the interior side, as shown on FIG. 3. The diameter of the counterbored hole 112 is slightly larger than the diameter of the beveled foot 142 but smaller than the flange 144. Referring to FIG. 5, the ball stud 140 is pressed into the counterbored hole using a conventional press such that the flange 144 displaces the sheet metal around the hole and the sheet metal cold flows in the recess between the angled portion of the beveled foot 142 and the flange. The beveled foot 142 thus acts to help secure the cold flow connection between the flange 144 and the sheet metal 110. As a result, the method of attachment is thus not visible from the exterior of the component.

Advantageously, since the hole in the panel is counterbored and not punched through, the back side of the panel remains unblemished and sealing requirements are maintained. However, the step of creating a counterbored hole in the panel is more expensive as it requires a machining step, whereas a thru-hole can be simply punched.

While the disclosure has been described in connection with specific embodiments, the disclosure is not limited to these embodiments, and that alterations, modifications, and variations of these embodiments may be carried out by the skilled person without departing from the scope of the disclosure.

1. A ball stud for mounting in a first panel, comprising:
a body having a top portion with a rounded protrusion and a bottom portion, the rounded protrusion sized for engagement with a mating fastener affixed in a second panel; and
a flange on the bottom portion of the body, the flange is larger than the bottom portion of the body and larger than a counterbored opening in the first panel;
a foot on the flange, the foot has a beveled edge, wherein a maximum size of the foot is smaller than the flange and smaller than the counterbored opening in the first panel.

2. The ball stud of claim 1, further comprising:
the foot is a frustum having a height that is slightly less than a thickness of the first panel; and
the beveled edge of the frustum is an acute angle.

3. A self-clinching ball stud for installation into a counterbored hole in a panel, the counterbored hole having a first diameter, comprising:
a body having a rounded head portion on top of a base portion;
a circular flange under the base portion, the circular flange having a second diameter larger than the first diameter; and
a beveled ring under the circular flange, the beveled ring having a maximum diameter smaller than the first diameter.

4. The self-clinching ball stud of claim 3, further comprising:
the beveled ring and flange have a combined height which is less than a height of the counterbored hole and the beveled ring has a beveled edge having an acute bevel angle cut from a bottom of the beveled ring to the circular flange.
